(19) United States
(12) Patent Application Publication
(10) Pub. No.: US 2026/0037075 A1
(43) Pub. Date: Feb. 5, 2026

(54) KEYBOARD

(71) Applicant: Logitech Europe S.A., Lausanne (CH)

(72) Inventor: Guanghui Hu, Suzhou City (CN)

(21) Appl. No.: 18/790,914

(22) Filed: Jul. 31, 2024

(51) Int. Cl. G06F 3/02; H01H 13/704; H01H 13/7065; H01H 13/86

(52) U.S. Cl. CPC G06F 3/0202; H01H 13/704; H01H 13/7065; H01H 13/86

(57) ABSTRACT

A keyboard may include a top case and a bottom case coupled with each other to define a internal compartment. Multiple internal layers are contained within the internal compartment. The multiple internal layers may include a plurality of keys mounted on a switch plate, wherein a portion of each of the plurality of keys protrudes over the top case; a printed circuit board (PCB) layer disposed under the switch plate; a gasket layer disposed under the PCB layer. The gasket layer comprises a peripheral wall and a bottom floor integrally formed with the peripheral wall. The switch plate is coupled with the peripheral wall of the gasket layer.

### BACKGROUND

The keyboard is one of the most frequently used computer peripheral devices. Common keyboards on the market are generally divided into two categories: membrane keyboards and mechanical keyboards. Mechanical keyboards use mechanical switches, and the keys have a longer key travel, which can give users a superior feel. However, conventional mechanical keyboards will produce relatively loud noise when typing. Therefore, there is a need in the field of keyboards to reduce the noise generated by keyboard tapping in mechanical keyboards.

### BRIEF SUMMARY OF THE INVENTION

The present disclosure generally describes a keyboard and a method for assembling the keyboard. In some embodiments, the keyboard may include a top case and a bottom case coupled with each other to define an internal compartment. Multiple internal layers are contained within the internal compartment. The multiple internal layers may include a plurality of keys mounted on a switch plate, wherein a portion of each of the plurality of keys protrudes over the top case (e.g., protrudes from a top surface of the top case); a printed circuit board (PCB) layer disposed under the switch plate; and a gasket layer disposed under the PCB layer. The gasket layer can comprise a peripheral wall and a bottom floor integrally formed with the peripheral wall. The switch plate can be coupled with the peripheral wall of the gasket layer.

In some embodiments, the switch plate includes at least one leg formed along a peripheral edge of the switch plate, wherein the at least one leg of the switch plate is coupled with the peripheral wall of the gasket layer.

In some embodiments, the gasket layer includes at least one slot formed in the peripheral wall, and each of the at least one leg is inserted in a respective one of the at least one slot.

In some embodiments, the at least one slot is formed at a lower end of the peripheral wall of the gasket layer adjacent to the bottom floor of the gasket layer.

In some embodiments, each of the at least one slot further includes a hang projection, and each of the at least one leg of the switch plate further comprises an extension portion and a foot portion, wherein the hang projection rests on the foot portion.

In some embodiments, the gasket layer includes at least one opening formed through the peripheral wall of the gasket layer.

In some embodiments, the PCB layer further includes at least one tab formed along a peripheral edge of the PCB layer, wherein each of the at least one tab passes through a respective one of the at least one opening formed through the peripheral wall of the gasket layer.

In some embodiments, the gasket layer further includes multiple support pins extending upward from a top surface of the bottom floor, wherein the PCB layer is supported on the multiple support pins.

In some embodiments, the multiple internal layers further include a first foam layer, wherein the first foam layer is disposed between the PCB layer and the bottom floor of the gasket layer.

In some embodiments, the multiple internal layers further include a switch foam layer, wherein the switch foam layer is disposed between the switch plate and the PCB layer.

A method for assembling a keyboard may include: forming a subassembly by: mounting a plurality of keys on a switch plate; and mounting a PCB layer to a bottom side of the switch plate. The method further includes mounting the subassembly in a gasket layer, wherein the gasket layer comprises a peripheral wall and a bottom floor integrally formed with the peripheral wall; coupling the switch plate with the peripheral wall of the gasket layer; mounting a bottom case to a bottom side of the gasket layer; mounting a top case over the subassembly and the gasket layer; and coupling the top case and the bottom case to each other.

In some embodiments, the switch plate includes at least one leg formed along a peripheral edge of the switch plate, wherein the coupling the switch plate with the peripheral wall of the gasket layer includes: coupling the at least one leg of the switch plate with the peripheral wall of the gasket layer.

In some embodiments, the gasket layer includes at least one slot formed in the peripheral wall, wherein the coupling the at least one leg of the switch plate with the peripheral wall of the gasket layer includes: inserting each of the at least one leg in a respective one of the at least one slot.

In some embodiments, the at least one slot is formed at a lower end of the peripheral wall of the gasket layer adjacent to the bottom floor of the gasket layer.

In some embodiments, each of the at least one slot further includes a hang projection, and each of the at least one leg of the switch plate further includes an extension portion and a foot portion, wherein the hang projection rests on the foot portion.

In some embodiments, the gasket layer includes at least one opening formed through the peripheral wall of the gasket layer.

In some embodiments, the PCB layer further includes at least one tab formed along a peripheral edge of the PCB layer, and the method further includes: passing each of the at least one tab through a respective one of the at least one opening formed through the peripheral wall of the gasket layer.

In some embodiments, the gasket layer further includes multiple support pins extending upward from a top surface of the bottom floor, wherein the PCB layer is supported on the multiple support pins.

In some embodiments, the forming the subassembly further includes: mounting a first foam layer, wherein the first foam layer is disposed between the PCB layer and the bottom floor of the gasket layer.

In some embodiments, the forming the subassembly further includes: mounting a first foam layer between the PCB layer and the bottom floor of the gasket layer.

In some embodiments, the forming the subassembly further includes: mounting a switch foam layer between the switch plate and the PCB layer.

In some embodiments, the forming the subassembly further includes: mounting a second foam layer between the switch foam layer and the switch plate.

Numerous benefits may be provided by embodiments of the present disclosure. For example, the switch plate is coupled with the gasket layer that is made of compressible and flexible material. Noise and vibration generated by key stroke when typing could be absorbed by the gasket layer. The gasket layer includes a one-piece trough structure with a peripheral wall and a bottom floor. The internal layers include the switch plate and the PCB layer may be contained in the trough of the gasket layer. The gasket layer can absorb the vibrations between the internal layers of keyboard during typing the keyboard. These and other benefits should be apparent to a person of skill in the art when reading the appended claims in light of the specification.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows a diagram of a keyboard according to some embodiments of the present disclosure;

FIG. 2 shows an exploded view of the keyboard according to some embodiments of the present disclosure;

FIG. 3A shows a diagram of the gasket layer of the keyboard according to some embodiments of the present disclosure;

FIG. 3B shows a partial diagram of the gasket layer of the keyboard, illustrating the cross section taken along the line A-A in FIG. 3A;

FIG. 4A shows a top view of the switch plate according to some embodiments of the present disclosure;

FIG. 4B shows a right side view of the switch plate according to some embodiments of the present disclosure;

FIG. 4C shows a bottom perspective view of the switch plate according to some embodiments of the present disclosure;

FIG. 5 shows a top view of the PCB layer according to some embodiments of the present disclosure;

FIG. 6A shows a cross sectional side view of the keyboard according to some embodiments of the present disclosure;

FIG. 6B shows an enlarged view of the areas B shown in FIG. 6A; and

FIG. 7 shows a flow chart of a method for assembling the keyboard according to some embodiments of the present disclosure.

### DETAILED DESCRIPTION

The present disclosure generally relates to computer peripherals. In particular, the present disclosure relates to embodiments of a keyboard.

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

A typical keyboard usually adopts a multi-layer structure with multiple internal layers contained in the compartment formed by a top case and bottom case. To reduce noise and vibrations generated during typing, absorptive materials can be added between internal layers and/or manufacturing can incorporate certain internal layers with noise absorptive materials. Some embodiments of the present disclosure contemplate manufacturing a gasket layer adjacent to the bottom case using compressible materials. In some embodiments, the gasket layer may include a one-piece structure with a peripheral side wall and a bottom floor. Some internal layers, such as a key switch plate on which the keys are mounted could rest on the gasket layer. In some embodiments, the peripheral side wall may support certain internal layers of the keyboard. For example, the gasket layer may form a trough in which certain internal layers of the keyboard may be contained. Some embodiments of the present disclosure will be further illustrated and described below.

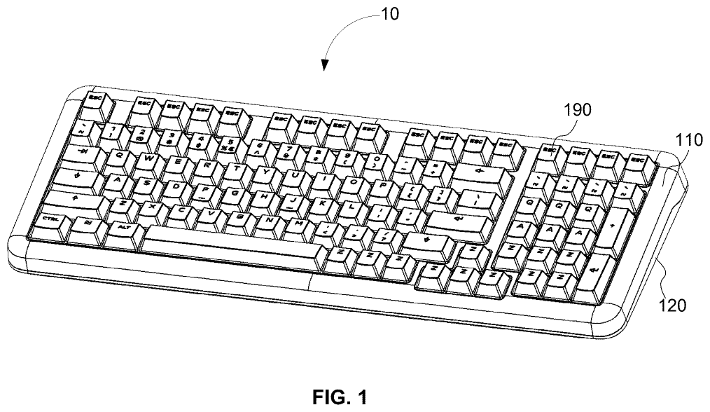

FIG. 1 shows a diagram of a keyboard 10 according to some embodiments of the present disclosure. As illustrated in FIG. 1, the keyboard 10 may include a top case 110 and a bottom case 120 coupled to each other. In some embodiments, the top case 110 and the bottom case 120 may define a internal compartment for accommodating multiple internal layers, which will be described below. A plurality of keys 190 protrude from the top case 110. A user may press each of the plurality of keys 190 to input a command to a connected computer (not shown) to effect input operation.

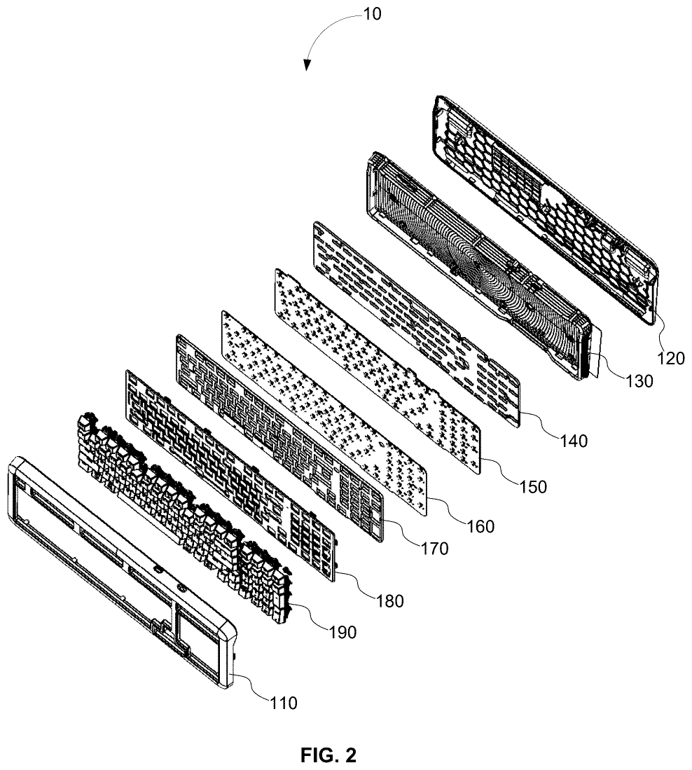

FIG. 2 shows an exploded view of the keyboard 10 according to some embodiments of the present disclosure. As illustrated, the keyboard 10 may include multiple internal layers disposed between the top case 110 and the bottom case 120. It should be noted that the keyboard 10 is shown in an upper-right perspective, with the top case 110 shown lower than the bottom case 120. In the actual keyboard 10 assembled, the top case 110 is on the top in the vertical direction and the bottom case 120 is on the bottom in the vertical direction. As shown in FIG. 2, the keyboard 10 may include a gasket layer 130 received in the bottom case 120. In some embodiments, the bottom case 120 may include multiple support pins extending from the top surface of the bottom case 120 to support the gasket layer 130. In some embodiments, the gasket layer 130 may also rest directly on the top surface of the bottom case 120. As shown in FIG. 2, the gasket layer 130 is configured as a trough shape, and may contain at least some of the internal layers of the keyboard 10 within its interior space. In some embodiments, a first foam layer 140, also called the bottom foam layer, may be disposed within the gasket layer 130. In some embodiments, the first foam layer 140 may rest on the bottom of the trough of the gasket layer 130. In some other embodiments, the gasket layer 130 may include multiple support pins extending from the upper surface of the trough bottom of the gasket layer 130 to support the first foam layer 140. It should be noted that the first foam layer 140 is not required in the keyboard 10, but can be included in certain embodiments as described herein. In some embodiments, the keyboard 10 may not include the first foam layer 140 to reduce the overall height of the keyboard 10. In some embodiments, a printed circuit board (PCB) layer 150 is disposed on the first foam layer 140. A user may press each of the plurality of keys 190, making portions of the keys to make contact with the PCB layer 150, causing PCB layer 150 to produce electrical signals that may be coupled to a connected computer as input data that can affect the input operation. In some other embodiments that do not include the first foam layer 140, the PCB layer 150 is disposed on the gasket layer 130, or supported by the multiple pins provided on the gasket layer 130.

In some embodiments, a switch foam layer 160 is disposed on the PCB layer 150 to provide additional noise and vibration absorption. It should be noted that the switch foam layer 160 is not required in the keyboard 10. As shown in FIG. 2, a second foam layer 170 is disposed on the switch foam layer 160 to provide additional noise and vibration absorption. In those embodiments that do not include the switch foam layer 160, the second foam layer 170 is disposed on the PCB layer 150 directly. It should be noted that the second foam layer 170 is not required in the keyboard 10 either. In some embodiments, a switch plate 180 is disposed on the second foam layer 170. The switch plate 180 may include a plurality of key holes for mounting of the plurality of keys 190 and provide structural support for the plurality of keys 190. Is some embodiments that do not include the second foam layer 170, the switch plate 180 may be disposed on the switch foam layer 160. Naturally, in some embodiments, if the keyboard 10 does not include a switch foam layer 160 either, the switch plate 180 may be disposed on the PCB layer 150 directly.

As shown in FIG. 2, the plurality of keys 190 may be mounted on the switch plate 180 with a portion of the key body passing through the key holes formed in the switch plate 180. Finally, the top case 110 may cover the stack of internal layers including the switch plate 180, the second foam layer 170, the switch foam layer 160, the PCB layer 150, the first foam layer 140, and the gasket layer 130. As shown in FIG. 2, the top case 110 may be configured as a frame with a void in a portion of the panel area to expose the key caps of the plurality of keys 190.

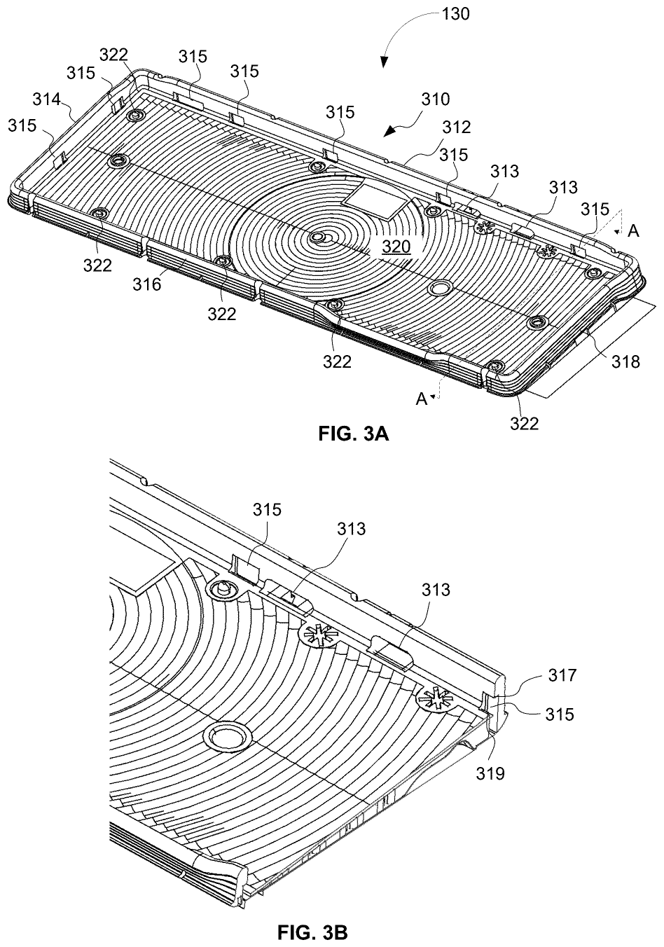

In some embodiments, some or all of the internal layers may be contained within the trough of the gasket layer 130 with the peripheral wall 310 (shown in FIG. 3A) of the gasket layer 130 surrounding the peripheral edges of these internal layers, as will be described in detail below.

FIG. 3A shows a diagram of the gasket layer 130 of the keyboard 10 according to some embodiments of the present disclosure. FIG. 3B shows a partial diagram of the gasket layer 130 of the keyboard 10, illustrating the cross section taken along the line A-A in FIG. 3A. As illustrated, the gasket layer 130 may be manufactured as a one-piece structure using, for example, extruding or molding process, in some embodiments. In some embodiments, the gasket layer 130 may include peripheral wall 310 and bottom floor 320 integrally formed with the peripheral wall 310. In some embodiments, the gasket layer 130 may be configured as a trough shape that can accommodating or containing other internal layers, such as the first foam layer 140 (when included), the PCB layer 150, the switch foam layer 160 (when included), the second foam layer 170 (when included), the switch plate 180, and a portion of the plurality of keys 190, shown in FIG. 2. The peripheral wall 310 may surround the peripheral edges of theses internal layers. In some embodiments, the gasket layer 130 may be made of compressible and/or flexible materials, such as silicon rubber, thermoplastic elastomer (TPE), and polyurethane (PU) foam, etc. These materials may help the gasket layer 130 to provide noise and vibration absorption for the keyboard 10.

As shown in FIG. 3A, in some embodiments, the peripheral wall 310 may include a first wall section 312, a second wall section 314, a third wall section 316, and a fourth section wall 318. In a typical rectangle keyboard layout, the first wall section 312 extends opposite and in parallel with the third wall section 316, and the second wall section 314 extends opposite and in parallel with the fourth wall section 318. It should be noted that it is not necessary that the wall sections 312-328 are configured in this way. In some embodiments not shown, the wall sections 312-318 may be configured to surround a different quadrangle, such as a parallelogram, a trapezoid, or other shape, for particular applications.

As shown in FIG. 3A, in some embodiments, the peripheral wall 310 may be coupled with the bottom floor 320 at the corner of intersection between the peripheral wall 310 and the bottom floor 320. In some embodiments, the thickness of the peripheral wall 310 may be a little greater than that of the bottom floor 320. For example, the peripheral wall 310 may have a thickness of 3-5 mm, and the bottom floor 320 may have a thickness of 1-3 mm. In some embodiments, the peripheral wall 310 is a continuous peripheral wall. It should be noted that the peripheral wall 310 is not required to be continuous. In some other embodiments not shown, the peripheral wall 310 may include small gaps at suitable positions along the peripheral wall 310. For example, these small gaps may provide spaces to help release stresses imposed on the peripheral wall 310 when the gasket layer 130 is assembled in the keyboard 10.

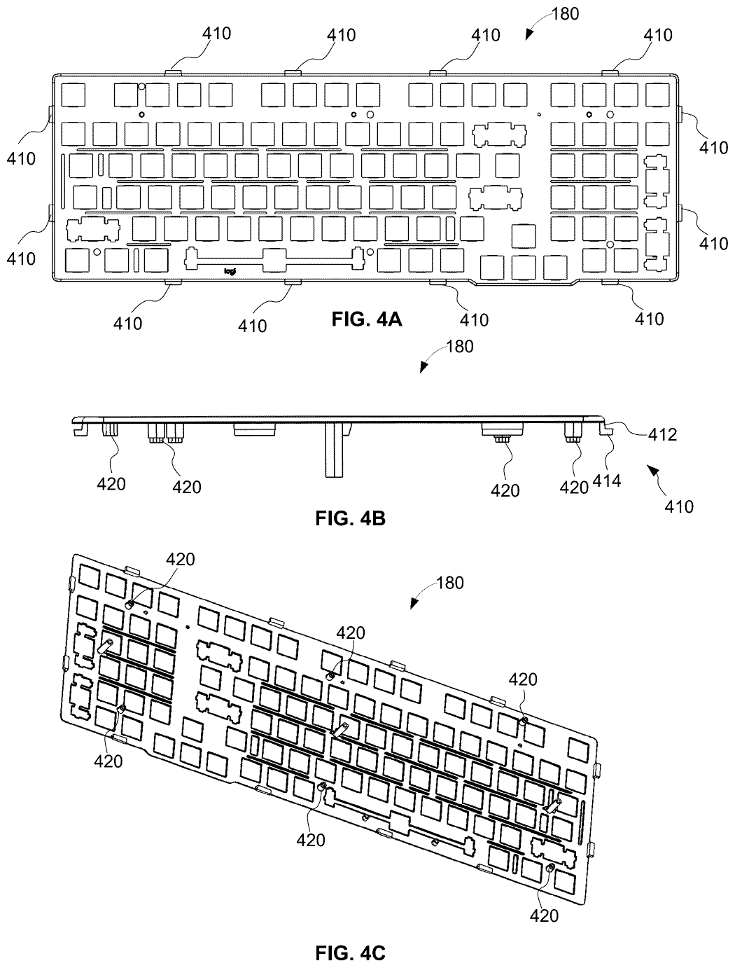

In some embodiments, the switch plate 180 (shown in FIG. 2) may be coupled with the peripheral wall 310 of the gasket layer 130. As shown in FIGS. 3A and 3B, in some embodiments, the peripheral wall 310 may include at least one slot 315 formed in the peripheral wall 310. Specifically, in some embodiments, the slot 315 may be formed at the lower end of the peripheral wall 310 adjacent to the bottom floor 320. In other words, the slot 315 may be formed at the corner where the peripheral wall 310 intersects the bottom floor 320 in some embodiments. As the keyboard 10 is assembled, a leg 410 (shown in FIGS. 4A and 4B) of the switch plate 180 may be inserted in the slot 315 to help the switch plate 180 to press the underling internal layers, such as the second foam layer 170 (if any), the switch foam layer 160 (if any), the PCB layer 150, and the first foam layer 140 (if any) against the bottom floor 320 of the gasket layer 130. This configuration may facilitate securing of these underlying internal layers configured within the trough of the gasket layer 130.

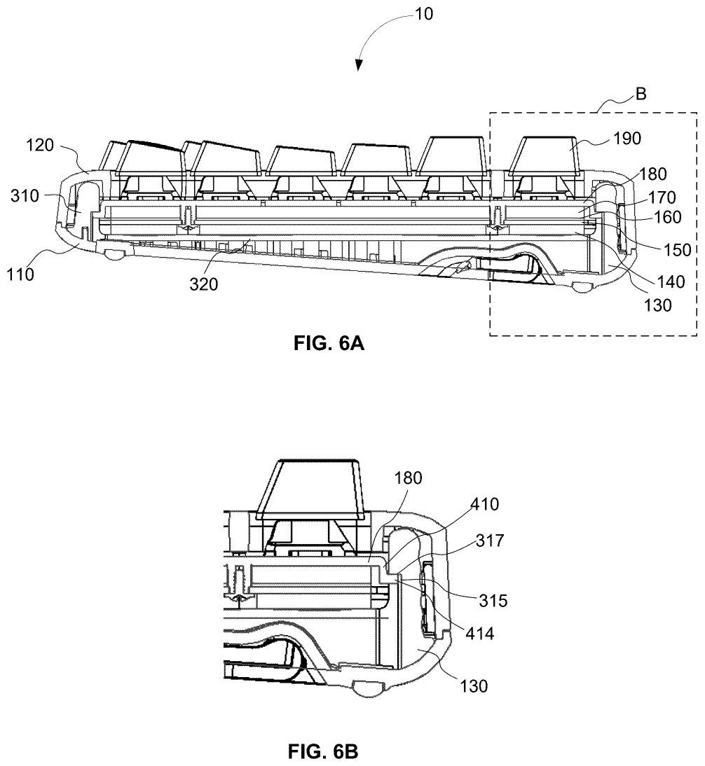

As shown in FIG. 3B, in some embodiments, the slot 315 may not pass through the total thickness of the peripheral wall 310. Instead, the slot 315 may cut into the peripheral wall 310 to a certain thickness less than the total thickness of the peripheral wall 310. In such case, a hang projection 317 can be formed in the peripheral wall 310. In some embodiments, the slot 315 may pass through the bottom floor 320 along the extending direction of the peripheral wall 310 to open to the bottom of the gasket layer 130. In some embodiments, the hang projection 317 may rest on a portion of the leg 410 (shown in FIGS. 4A-4B) of the switch plate 180 to prevent or reduce switch plate 180 movement in the vertical direction, as further described below with reference to FIGS. 6A-6B.

As shown in FIG. 3B, the slot 315 may include a platform 319 extending upward from the bottom floor 320 of gasket layer 130. In some embodiments, the platform 319 may enclose the slot 315. In some embodiments, the PCB layer 150 may rest on the platform 319.

As shown in FIG. 3A, the peripheral wall 310 may include a plurality of slots 315 disposed at suitable positions along the peripheral wall 310. For example, as shown in FIG. 3A, the first wall section 312 may include four slots 315, and the second wall section 314 may include one slot 315. Though not shown in FIG. 3A, it should be understood that the wall sections 316 and 318 may also include one or more slots 315. In some embodiments, the switch plate 180 may include corresponding legs 410 (shown in FIGS. 4A-4B) to be inserted into the slots 315 formed in the peripheral wall 310. In some embodiments, the switch plate 180 may include a fewer number of legs 410 (shown in FIGS. 4A-4B) than that of the slots 315 formed in the peripheral wall 310. Such a configuration may provide design redundance for the gasket layer 130 to accommodate different switch plates 180 with different numbers of legs 410. It should be noted that FIG. 3B shows only the detail of one slot 315, and that the remaining slots 315 may share the same structure and configuration. In some embodiments, as shown in FIG. 3A, these slots 315 may have different lengths along the wall sections in which they are formed. Naturally, in some other embodiments, these slots 315 may have the same length.

As shown in FIG. 3A, in some embodiments, the bottom floor 320 may include multiple support pins 322 disposed on certain positions over the bottom floor 320. In some embodiments, each of the support pins 322 may extend upward from the bottom floor 320 to certain height, such as 1-3 mm. In some embodiments, the above internal layers, such as the first foam layer 140 may be supported on the support pins 322. In some embodiments not shown, the bottom floor 320 may not include the support pins 322. In such cases, the above internal layers, such as the first foam layer 140, may directly rest on the bottom floor 320.

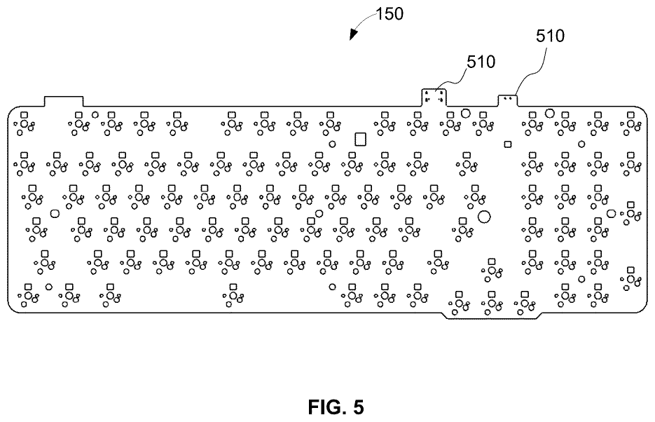

As shown in FIG. 3A, in some embodiments, the peripheral wall 310 may include at least one opening 313 extending through the thickness of the peripheral wall 310. In some embodiments, the opening 313 may provide a passage for a tab 510 (shown in FIG. 5) formed in the PCB layer 150 to connect with external interfaces of a connected computer, such as a USB port, a type-C port, etc.

FIG. 4A shows a top view of the switch plate 180 according to some embodiments of the present disclosure. FIG. 4B shows a right side view of the switch plate 180, according to some embodiments of the present disclosure. FIG. 4C shows a bottom perspective view of the switch plate 180, according to some embodiments of the present disclosure. As illustrated in FIG. 4A, the switch plate 180 may include at least one leg 410 formed along a peripheral edge of the switch plate 180. As the keyboard 10 is assembled, the leg 410 may be inserted into a corresponding slot 315 (shown in FIG. 3A). As shown in FIG. 4B, the leg 410 may include an extension portion 412 and a foot portion 414 coupled with the extension portion 412. Referring to FIG. 3B, as the leg 410 is inserted into the slot 315, the hang projection 317 may rest on the upper surface of the foot portion 414 to prevent the vertical movement of the leg 410 in the slot 315, which will be further described below with reference to FIGS. 6A-6B.

As shown in FIGS. 4B and 4C, in some embodiments, the switch plate 180 may include multiple support pins 420 extending from the bottom surface of the switch plate 180. In some embodiments, the support pins 420 may pass through the underling internal layers, such as the second foam layer 170 (when included), the switch foam layer 160 (when included), the PCB layer 150, and the first foam layer 140 (when included), as shown in FIG. 2, to rest on the upper surface of the bottom floor 320 (shown in FIG. 3A) of the gasket layer 130. In such a configuration, the support pins 420 may prevent the switch plate 180 and the underling internal layers from sagging. In some other embodiments, the switch plate 180 may not include support pins 420.

FIG. 5 shows a top view of the PCB layer 150, according to some embodiments of the present disclosure. As illustrated, in some embodiments, the PCB layer 150 may include at least one tab 510 formed along a peripheral edge of the PCB layer 150. In some embodiments, the tab 510 may pass through the opening 313 (shown in FIG. 3A) formed in the peripheral wall 310 of the gasket layer 130. For example, the tab 510 may include an interface circuit, such as a USB port circuit, a Type-C port circuit. In this configuration, the keyboard 10 may provide electrical connections for these interface circuits with a connected computer outside of the keyboard 10.

FIG. 6A shows a cross sectional side view of the keyboard 10, according to some embodiments of the present disclosure. FIG. 6B shows an enlarged view of the areas B shown in FIG. 6A. As illustrated in FIG. 6A, in some embodiments, the keyboard 10 may include the top case 110 and the bottom case 120 coupled with each other. An internal compartment is defined between the top case 110 and the bottom case 120 to accommodate the internal layers, including the gasket layer 130, the first foam layer 140 (when included), the PCB layer 150, the switch foam layer 160 (when included), the second foam layer 170 (when included), the switch plate 180, and a portion of the plurality of keys 190. As illustrated, the gasket layer 130 is configured as a trough shape with the peripheral wall 310 and the bottom floor 320. In some embodiments, the trough of the gasket layer 130 can accommodate the internal layers, such as the first foam layer 140 (when included), the PCB layer 150, the switch foam layer 160 (when included), the second foam layer 170 (when included), the switch plate 180, and a portion of the plurality of keys 190. In other words, the peripheral wall 310 surrounds the peripheral edges of these internal layers.

In some embodiments, as shown in FIG. 6B, the switch plate 180 is coupled to the peripheral wall 310 of the gasket layer 130. In this configuration, the switch plate 180 may press the underling layers, including the second foam layer 170 (when included), the switch foam layer 160 (when included), the PCB layer 150, the first foam layer 140 (when included) to rest on the upper surface of the bottom floor 320 of the gasket layer 130. In alternative embodiments, if the gasket layer 130 includes support pins 322 (shown in FIG. 3A), the switch plate 180 may press the underling layers to rest on the support pins 322 on the bottom floor 320 of the gasket layer 130. When a user presses the keys 190 of the keyboard 10, the noise and vibration generated by the key stroke may be absorbed and/or damped by the material of the gasket layer 130.

As shown in FIG. 6B, in some embodiments, the leg 410 of the switch plate 180 may be inserted in the slot 315 formed in the peripheral wall 310 of the gasket layer 130, with the hang projection 317 coupling the upper surface of the foot portion 414 of the leg 410. In such a configuration, the coupling between hang projection 317 of the gasket layer 130 and the leg 410 of the switch plate 180 may prevent the vertical movement of the switch plate 180, together with underlying internal layers, with respect to the gasket layer 130.

In another aspect of the present disclosure, a method for assembling the keyboard 10 is proposed. As the first part of the method, a subassembly including the plurality of keys 190, the switch plate 180, the second foam layer 170 (when included), the switch foam layer 160 (when included), the PCB layer 150, and the first foam layer 140 (when included) is formed or assembled. Then the subassembly may be mounted in the gasket layer 130 with the switch plate 180 coupled with the gasket layer 130. Next, the top case 110 mounted on the top of the subassembly. Finally, the bottom case 120 is mounted on the bottom of the gasket layer 130, with the bottom case 120 coupled to the top case 110.

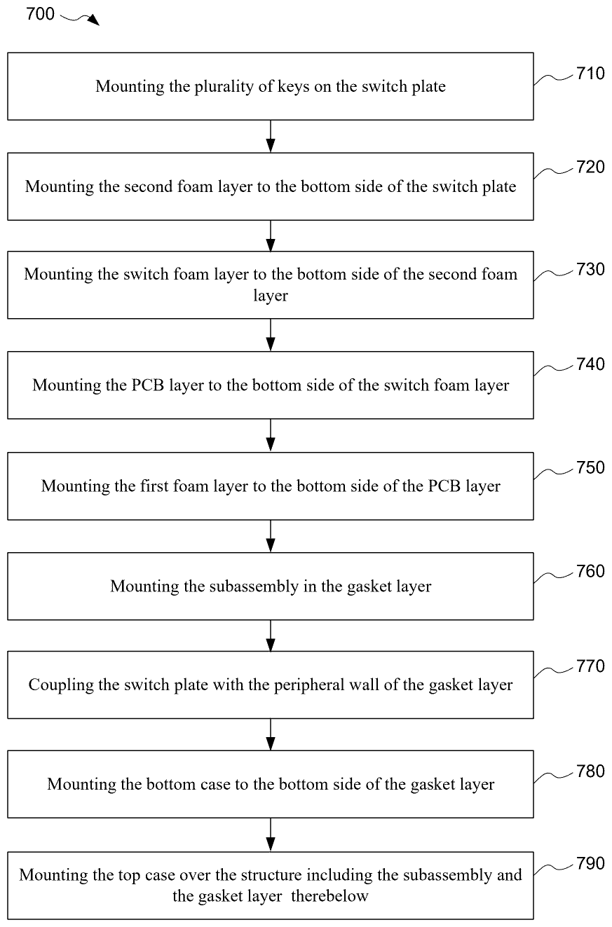

FIG. 7 shows a flow chart of a method 700 for assembling the keyboard 10, according to some embodiments of the present disclosure. The method 700 will be described with reference to FIGS. 2 and 6A-6B. Step 710 includes mounting the plurality of keys 190 on the switch plate 180. Specifically, the step includes mounting each of the plurality of keys 190 through the respective key holes formed in the switch plate 180, with an upper portion of each key 190 protruding from the top surface of the switch plate 180, and a lower portion of each key 190 protruding from the bottom surface of the switch plate 180. At step 720, the method 700 may include mounting the second foam layer 170 to the bottom side of the switch plate 180. In some embodiments, the top side of the second foam layer 170 may include adhesive. In such cases, the top side of the second foam layer 170 may be attached to the bottom side of the switch plate. Naturally, in some embodiments that do not include the second foam layer 170, step 720 may be omitted. At step 730, the method 700 may include mounting the switch foam layer 160 to the bottom side of the second foam layer 170. In some embodiments, the top side of the second foam layer 170 may include adhesive. In such cases, the top side of the switch foam layer 160 may be attached to the bottom side of the second foam layer 170. Naturally, in some embodiments that do not include the switch foam layer 160, the step 730 may be omitted. At step 740, the method 700 may include mounting the PCB layer 150 to the bottom side of the switch foam layer 160. Naturally, in some embodiments that do not include the switch foam layer 160 and the second foam layer 170, the PCB layer 150 can be mounted to the bottom side of the switch plate 180. At step 750, the method 700 may include mounting the first foam layer 140 to the bottom side of the PCB layer 150. In some embodiments, the top side of the first foam layer 140 may include adhesive. In such case, the top side of the first foam layer 140 may be attached to the bottom side of the PCB layer 150. Naturally, in some embodiments that do not include the first foam layer 140, step 750 may be omitted. Thus, the subassembly including the plurality of keys 190, the switch plate 180, the second foam layer 170 (when included), the switch foam layer 160 (when included), the PCB layer 150, and the first foam layer 140 (when included) is assembled. It should be noted that the first foam layer 140, the switch foam layer 160, and the second foam layer 170 are optional. In some embodiments, the subassembly may include only the plurality of keys 190, the switch plate 180, and the PCB layer 150. The corresponding steps for mounting the other optional internal layers described above may be omitted.

After the subassembly is formed, at step 760, the method 700 may include mounting the subassembly in the gasket layer 130. Then at step 770, the method 700 may include coupling the switch plate 180 with the peripheral wall 310 of the gasket layer 130. Specifically, this step may include coupling the leg 410 of the switch plate 180 with the peripheral wall 310 of the gasket layer 130, for example, by inserting the leg 410 (shown in FIG. 6B) of the switch plate 180 in the slot 315 formed in the peripheral wall 310 of the gasket layer 130. It should be understood that the material of the gasket layer 130 is compressible and flexible. The insertion of the leg 410 in the slot 315 of the peripheral wall 310 may temporarily deform the peripheral wall 310 of the gasket layer 130. After the insertion, the peripheral wall 310 may return to its configuration before deformation. Then, this step may include passing through the tabs 510 (shown in FIG. 5) formed in the PCB layer 150 through the openings 313 (shown in FIG. 3A) formed in the peripheral wall 310 of the gasket layer 130.

At step 780, the method may include mounting the bottom case 120 to the bottom side of the gasket layer 130. Then at step 790, the method may include mounting the top case 110 over the structure including the subassembly and the gasket layer 130 there below. Finally, the top case 110 and the bottom case 120 may be coupled together by fasteners, such as screws, or other suitable coupling implementation.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known structures and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing embodiments of the invention. Various changes may be made in the function and arrangement of elements without departing from the spirit and scope of the invention.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of +20% or +10%, +5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of +20% or +10%, +5%, or +0.1% from the specified value, as such variations are appropriate to in the context of the systems, devices, circuits, methods, and other implementations described herein.

Where a range of values is provided, it is understood that each intervening value, to the smallest fraction of the unit of the lower limit, unless the context clearly dictates otherwise, between the upper and lower limits of that range is also specifically disclosed. Any narrower range between any stated values or unstated intervening values in a stated range and any other stated or intervening value in that stated range is encompassed. The upper and lower limits of those smaller ranges may independently be included or excluded in the range, and each range where either, neither, or both limits are included in the smaller ranges is also encompassed within the technology, subject to any specifically excluded limit in the stated range. Where the stated range includes one or both of the limits, ranges excluding either or both of those included limits are also included.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

What is claimed is:

1. A method for assembling a keyboard, comprising:
forming a subassembly by:
mounting a plurality of keys on a switch plate; and
mounting a PCB layer to a bottom side of the switch plate;
mounting the subassembly in a gasket layer, wherein the gasket layer comprises a peripheral wall and a bottom floor integrally formed with the peripheral wall;
coupling the switch plate with the peripheral wall of the gasket layer;
mounting a bottom case to a bottom side of the gasket layer;
mounting a top case over the subassembly and the gasket layer; and
coupling the top case and the bottom case to each other.

2. The method of claim 1, wherein the switch plate comprises at least one leg formed along a peripheral edge of the switch plate, wherein the coupling the switch plate with the peripheral wall of the gasket layer comprises:
coupling the at least one leg of the switch plate with the peripheral wall of the gasket layer.

3. The method of claim 2, wherein the gasket layer comprises at least one slot formed in the peripheral wall, wherein the coupling the at least one leg of the switch plate with the peripheral wall of the gasket layer comprises:
inserting each of the at least one leg in a respective one of the at least one slot.

4. The method of claim 3, wherein the at least one slot is formed at a lower end of the peripheral wall of the gasket layer adjacent to the bottom floor of the gasket layer.

5. The method of claim 3, wherein each of the at least one slot further comprises a hang projection, and each of the at least one leg of the switch plate further comprises an extension portion and a foot portion, wherein the hang projection rests on the foot portion.

6. The method of claim 2, wherein the gasket layer comprises at least one opening formed through the peripheral wall of the gasket layer.

7. The method of claim 6, wherein the PCB layer further comprises at least one tab formed along a peripheral edge of the PCB layer, and the method further comprises:
passing each of the at least one tab through a respective one of the at least one opening formed through the peripheral wall of the gasket layer.

8. The method of claim 1, wherein the gasket layer further comprises multiple support pins extending upward from a top surface of the bottom floor, wherein the PCB layer is supported on the multiple support pins.

9. The method of claim 1, wherein the forming the subassembly further comprises:
mounting a first foam layer, wherein the first foam layer is disposed between the PCB layer and the bottom floor of the gasket layer.

10. The method of claim 1, wherein the forming the subassembly further comprises:
mounting a first foam layer between the PCB layer and the bottom floor of the gasket layer.

11. The method of claim 1, wherein the forming the subassembly further comprises:
mounting a switch foam layer between the switch plate and the PCB layer.

12. The method of claim 11, wherein the forming the subassembly further comprises:
mounting a second foam layer between the switch foam layer and the switch plate.
